(19) United States
(12) Patent Application Publication
(10) Pub. No.: US 2025/0384414 A1
(43) Pub. Date: Dec. 18, 2025

(54) SYSTEMS AND METHODS FOR DYNAMIC PROCESSING OF A HIGH-VOLUME OF TRANSACTIONS

(71) Applicant: JPMORGAN CHASE BANK, N.A., New York, NY (US)

(72) Inventors: Nicholas JOHNSTON, Poole (GB); Dinesh Babu PARTHASARATHI, Bournemouth (GB); Kevin LOBO, Wimborne (GB); Paul AMOR, Blandform Forum (GB)

(21) Appl. No.: 19/242,208

(22) Filed: Jun. 18, 2025

Related U.S. Application Data
(60) Provisional application No. 63/661,279, filed on Jun. 18, 2024.

(51) Int. Cl. G06Q 20/10

(52) U.S. Cl. CPC G06Q 20/10

(57) ABSTRACT

A method may include a transaction processor: receiving a first transaction for an account; determining that there is not an active high-volume record lock on an account record for the account; acquiring a lock on the account record; receiving a second transaction for the account; attempting to acquire a lock on the account record; determining, in response to being unable to acquire a lock on the account record, that a lock acquire duration exceeds a lock acquire duration threshold; inserting an active high-volume record into a lock table; creating an interim balance record for the account that aggregates transactions received when the active high-volume record is active; receiving a third transaction for the account; determining that an idle duration between the third transaction and the second transaction does not exceed an idle duration threshold; and deleting the active high-volume record from the lock table and the interim balance records.

### RELATED APPLICATIONS

This application claims priority to, and the benefit of, U.S. Provisional Patent Application Ser. No. 63/661,279, filed Jun. 18, 2024, the disclosure of which is hereby incorporated, by reference, in its entirety.

### BACKGROUND OF THE INVENTION

### 1. Field of the Invention

Embodiments relate to systems and methods for dynamic processing of a high-volume of transactions.

### 2. Description of the Related Art

When processing a large number of transactions for a corporate client, such as a merchant, the number of transactions that can be processed per second can be impacted due to account locking. For example, when the number of concurrent transactions exceeds a threshold, the account may be locked, thereby impacting the rate at which those and other transactions are processed.

### SUMMARY OF THE INVENTION

Systems and methods for dynamic processing of a high-volume of transactions are disclosed. In one embodiment, a method may include: receiving, at a transaction processor computer program, a first transaction for an account; determining, by the transaction processor computer program, that there is not an active high-volume record lock on an account record for the account; acquiring, by the transaction processor computer program, a lock on the account record; receiving, by the transaction processor computer program, a second transaction for the account; attempting, by the transaction processor computer program, to acquire a lock on the account record; determining, by the transaction processor computer program and in response to being unable to acquire a lock on the account record, that a lock acquire duration exceeds a lock acquire duration threshold; inserting, by the transaction processor computer program, an active high-volume record into a lock table; creating, by the transaction processor computer program, an interim balance record for the account, wherein the interim balance record aggregates transactions received when the active high-volume record is in the lock table; receiving, by the transaction processor computer program, a third transaction for the account; determining, by the transaction processor computer program, that an idle duration between the third transaction and the second transaction does not exceed an idle duration threshold; and deleting, by the transaction processor computer program, the active high-volume record from the lock table and the interim balance records.

In one embodiment, the method may also include publishing, by the transaction processor computer program, an account balance event to balance consumers.

In one embodiment, the transaction processor computer program acquires the lock on the account record via a lock manager application programming interface.

In one embodiment, the lock acquire duration indicates whether the account record is being updated by concurrent processes for a period of time. In one embodiment, the method may also include merging, by the transaction processor computer program, the interim balance record for the account with the account record.

In one embodiment, the method may also include deleting, by the transaction processor computer program, the interim balance record after the merging.

According to another embodiment, a system may include: a money movement platform; a global load balancer in communication with the money movement platform; a plurality of gateways in communication with the global load balancer; a transaction processor associated with each of the gateways; and a data store associated with each transaction processor. The global load balancer is configured to receive a first transaction for an account from the money movement platform; the global load balancer is configured to route the first transaction to one of the gateways; the gateway is configured to route the first transaction to its transaction processor; the transaction processor is configured to determine that there is not an active high-volume record lock on an account record for the account; the transaction processor is configured to acquire a lock on the account record; the transaction processor is configured to receive a second transaction for the account; the transaction processor is configured to attempts to acquire a lock on the account record; the transaction processor is configured to determine, in response to being unable to acquire a lock on the account record, that a lock acquire duration exceeds a lock acquire duration threshold; the transaction processor is configured to insert an active high-volume record into a lock table; the transaction processor is configured to create an interim balance record for the account, wherein the interim balance record aggregates transactions received when the active high-volume record is in the lock table; the transaction processor is configured to receive a third transaction for the account; the transaction processor is configured to determine that an idle duration between the third transaction and the second transaction does not exceed an idle duration threshold; and the transaction processor is configured to delete the active high-volume record from the lock table and the interim balance records.

In one embodiment, the global load balancer is configured to route the first transaction to one of the gateways using an algorithm.

In one embodiment, the transaction processor is configured to publish an account balance event to balance consumers.

In one embodiment, the transaction processor is configured to acquire the lock on the account record via a lock manager application programming interface.

In one embodiment, the lock acquire duration indicates whether the account record is being updated by concurrent processes for a period of time.

In one embodiment, the transaction processor is configured to merge the interim balance record for the account with the account record.

In one embodiment, the transaction processor is configured to delete the interim balance record after the merging.

According to another embodiment, a non-transitory computer readable storage medium may include instructions stored thereon, which when read and executed by one or more computer processors, cause the one or more computer processors to perform steps comprising: receiving a first transaction for an account; determining that there is not an active high-volume record lock on an account record for the account; acquiring a lock on the account record; receiving a second transaction for the account; attempting to acquire a lock on the account record; determining, in response to being unable to acquire a lock on the account record, that a lock acquire duration exceeds a lock acquire duration threshold; inserting an active high-volume record into a lock table; creating an interim balance record for the account, wherein the interim balance record aggregates transactions received when the active high-volume record is in the lock table; receiving a third transaction for the account; determining that an idle duration between the third transaction and the second transaction does not exceed an idle duration threshold; and deleting the active high-volume record from the lock table and the interim balance records.

In one embodiment, the non-transitory computer readable storage medium may also include including instructions stored thereon, which when read and executed by the one or more computer processors, cause the one or more computer processors to perform steps comprising: publishing an account balance event to balance consumers.

In one embodiment, the lock on the account record is acquired via a lock manager application programming interface.

In one embodiment, the lock acquire duration indicates whether the account record is being updated by concurrent processes for a period of time.

In one embodiment, the non-transitory computer readable storage medium may also include including instructions stored thereon, which when read and executed by the one or more computer processors, cause the one or more computer processors to perform steps comprising: merging the interim balance record for the account with the account record.

In one embodiment, the non-transitory computer readable storage medium may also include including instructions stored thereon, which when read and executed by the one or more computer processors, cause the one or more computer processors to perform steps comprising: deleting the interim balance record after the merging.

### BRIEF DESCRIPTION OF THE DRAWINGS

For a more complete understanding of the present invention, the objects, and advantages thereof, reference is now made to the following descriptions taken in connection with the accompanying drawings in which:

FIG. 1 illustrates a system for dynamic processing of a high-volume of transactions according to an embodiment;

FIGS. 2A, 2B, and 2C illustrate a method for entering a mode for dynamic processing of a high-volume of transactions according to an embodiment;

FIG. 3 depicts an exemplary computing system for implementing aspects of the present disclosure.

### DETAILED DESCRIPTION OF PREFERRED EMBODIMENTS

Systems and methods for dynamic processing of a high-volume of transactions are disclosed.

Embodiments may enable high-volume transaction processing capability based on the volume of transactions received for an account.

Embodiments may define one or more design patterns for transaction processing that have consistent throughput performance that is not impacted by the volume of concurrent transactions against a single account.

Embodiments may provide some or all of the following: (1) embodiments may have consistent transactions per second (TPS) throughput regardless of the number of transactions requiring a balance to be updated at a point in time; (2) embodiments may be able to process a large volume (e.g., thousands) of transaction against a single account without impacting performance by concurrent blocking of updates; (3) embodiments may be able to toggle between high and low concurrency modes based on runtime volume characteristics; (4) embodiments may generate a locked indicative/soft balance at configurable intervals when an account is in high-volume mode; (5) embodiments may publish a balance at point in time based on movement that has been received to that point in time; and (6) embodiments may force a balance update through request to have a “committed” balance.

Embodiments may provide some or all of the following technical advantages: (1) embodiments may provide intelligence within the system to toggle between high-volume transaction mode and non-high-volume transaction mode based on the runtime volume; (2) embodiments may reduce the total number of balance events sent out sending out pre-merge balance events when in high-volume transaction modes; and (3) embodiments may offer consistent throughput performance regardless of the volume of transaction processed against the account.

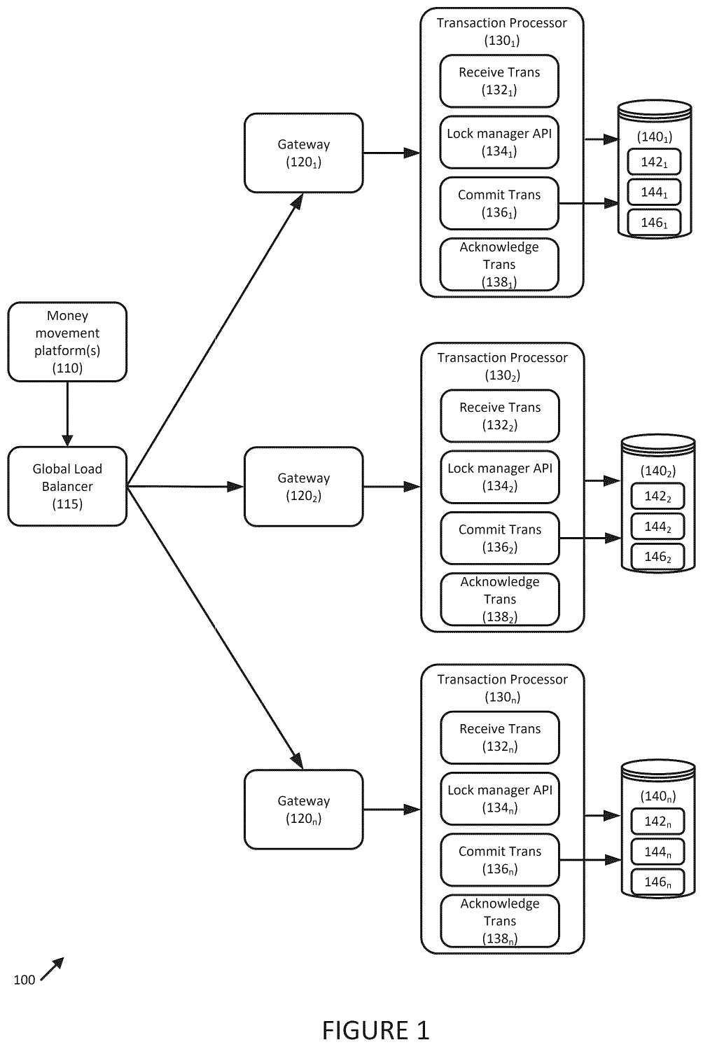

Referring to FIG. 1, a system for dynamic processing of a high-volume of transactions is disclosed according to an embodiment. System 100 may include one or more money movement platforms 110, global load balancer 115, and gateways 120 (i.e., gateway 1201, gateway 1202, . . . gateway 120n). Each gateway 120 may be associated with a transaction processor 130 (i.e., transaction processor 1301, transaction processor 130n, . . . transaction processor 130n). Each transaction processor 130 may be provided with modules, such as receive transaction module 132 (e.g., receive transaction module 1321, receive transaction module 1322, . . . receive transaction module 132n), lock manager API 134 (e.g., lock manager API 1341, lock manager API 1342, . . . lock manager API 134n), commit transaction module 136 (e.g., commit transaction module 1361, commit transaction module 1362, . . . commit transaction module 136n), and acknowledge transaction module 138 (e.g., acknowledge transaction module 1381, acknowledge transaction module 1382, . . . acknowledge transaction module 138n). Each transaction processor may be associated with data store 140 (e.g., data store 1401, data store 1402, . . . data store 140n), and each data store 140 may maintain account records 142 (e.g., account record 1421, account record 1422, . . . account record 142n) for each account. Each account may have its own account record 142.

In one embodiment, each set of gateway 120, transaction processor 130, and data store 140 may be considered to be a pod.

Global load balancer 115 may select one of gateways 120 based on a load balancing algorithm. Gateways 120 may be software-based and may perform parallel processing.

Gateways 120 may convert the transactions to a format for transaction processors 130 as is necessary and/or desired.

Each transaction processor 130 may receive transactions from its gateway 120 as, for example REST API calls. The transactions may include single-sided debits or credits that may be applied to an account balance, such as a cash account balance.

Transaction processors 130 may validate the structure and mandatory fields in a transaction, and may attempt to lock the account balance for the involved account in order to calculate the account balance, to update the account balance, and to persist the account balance to data store 140.

For example, receive transaction module 132 may receive the transaction, lock manager API 134 may attempt to lock account record 142 in data store 140, or may release the lock, commit transaction module 136 may commit the transaction to account record 142, and acknowledge transaction module 138 may acknowledge the transaction.

In one embodiment, data store 140 may be a single data store, or multiple data stores. Data stores 140 allow account record 142 to be processed by multiple transaction processors 130 concurrently.

Data stores 140 may also store interim balance record 144 (e.g., interim balance record 1441, interim balance record 1442, . . . interim balance record 144n) and active high-volume records 146 (e.g., active high-volume record 1461, active high-volume record 1462, . . . active high-volume record 146n). Active high-volume records 146 may be stored in an active high-volume lock table.

Transaction processors 130 may determine whether to process transactions in a high-volume transaction mode. For example, if it takes a certain amount of time (this time may be configurable) to acquire a lock on the account balance record for the transaction, transaction processors 130 may identify this as an indicator of significant concurrency on the account. Transaction processors 130 may put the account into high-volume transaction mode by inserting an active high-volume record 146 in the active high-volume lock table with a primary key (e.g., account.xyz.time.intervalid.transactionidentifier) in data store 140.

The active high-volume record 146 may be a record that belongs to the transaction process. It may be created with its own process identifier and account when the account cannot be locked. The active high-volume record may record transaction movement aggregating balances for the individual transactions that are processed by individual processes until high-volume transaction mode is exited.

When in high-volume transaction mode, instead of the account balance being updated, a separate record that is linked to the transaction processing threads executed by transaction processors 130. This maintains performance regardless of the number of concurrent transactions for an account because there is no waiting for a lock when exiting high-volume transaction mode.

As transaction processors 130 process subsequent transactions, they may check to see whether the account is in the high-volume transaction mode before trying to perform an update on the account balance record.

If the account record is in high-volume transaction mode, transaction processors 130 will not try and lock the balance record for account record 142 in data store 140, but may instead create a new interim balance record 144 with a process/pod (e.g., transaction processor) identifier. This means that there is no lock contention as all updates are performed on the interim (e.g., pod level) balance records that has the process/pod ID in the primary key relating to the individual pod.

Transaction processors 130 may exit high-volume processing mode by checking the timestamp for the last committed transaction. If the elapsed time from the last committed transaction to the transaction time exceeds the idle time parameter that may be set, the process will exit high the high-volume transaction mode.

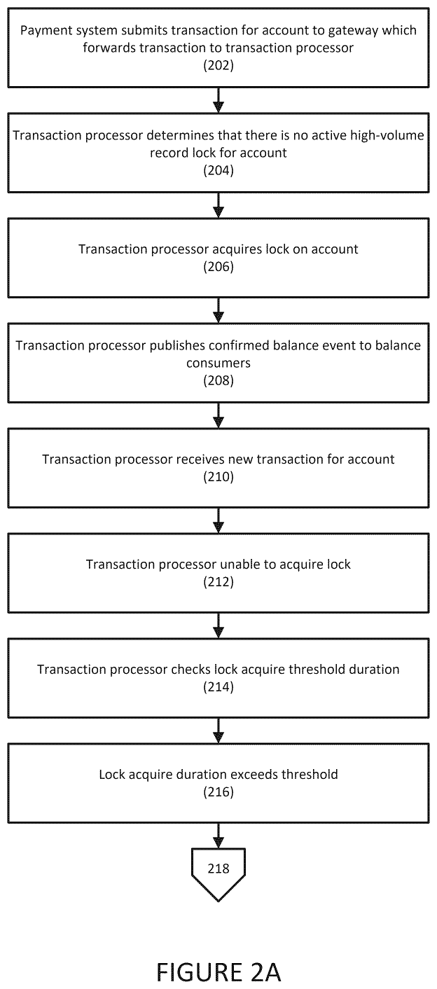

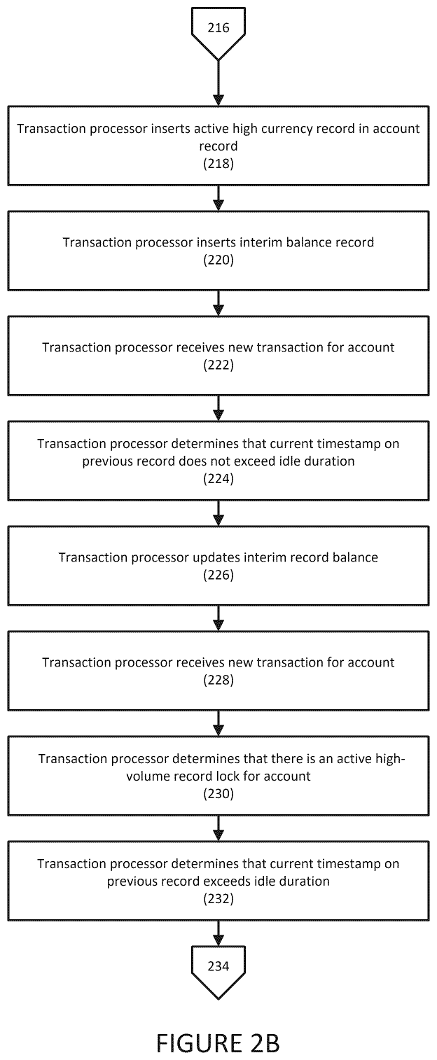

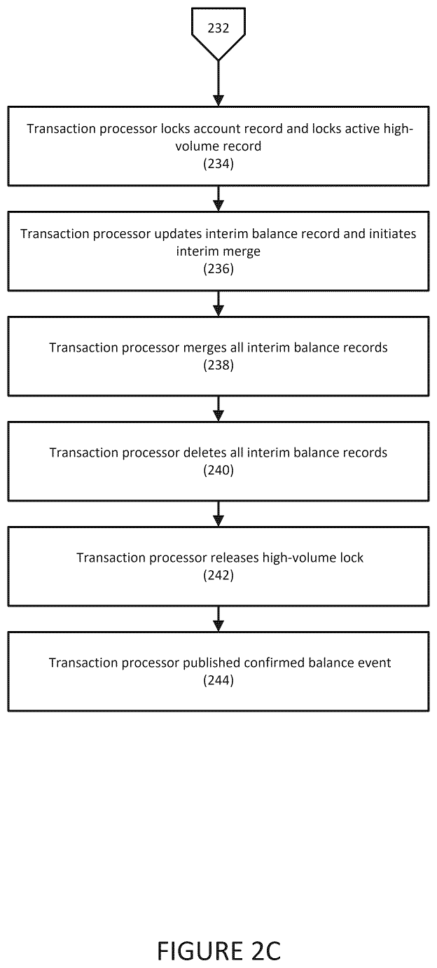

Referring to FIGS. 2A, 2B, and 2C, a method for dynamic processing of a high-volume of transactions is disclosed according to an embodiment.

In step 202, a payment system may submit a transaction for account to gateway which forwards transaction to transaction processor.

In step 204, the transaction processor may determine that there is no active high-volume record lock for account. For example, the transaction processor may check the account record for an account lock.

In step 206, the transaction processor may acquire a lock on the account record. For example, the transaction processor may initiate a lock via lock manager API, which will call a data store to lock the account record for the account.

In step 208, the transaction processor may execute the transaction and may publish a confirmed balance event to balance consumers, such as operational data stores, analytic stores, fund control systems, etc.

In step 210, the transaction processor may receive a new transaction for the account and may attempt to acquire a lock on the account record, and in step 212, the transaction processor is unable to acquire a lock on the account record.

In step 214, the transaction processor may retrieve a lock acquire duration threshold for the account. The lock acquire duration threshold may represent a configurable period of time. When the lock acquire duration threshold is exceeded, this means that, the account record has been updated by concurrent processes for a sustained period of time, and therefore is a saturated resource that may be blocking other processes from completing.

In step 216, if the lock acquire duration exceeds the lock acquire duration threshold, in step 218, the transaction processor may insert an active high-volume record into an active high-volume record lock table.

The lock acquire duration may start when the transaction processor first tries to acquire the lock and is unsuccessful.

In step 220, the transaction processor may create insert an interim balance record in the data store. The interim balance record aggregates the transaction movements that are written to an interim ledger for that process until it can update the consolidate account balance for all the movements from all processes that have been made for that account.

In step 222, the transaction processor may receive a new transaction for the account.

In step 224, the transaction processor may review the timestamp on the timestamp for the new transaction and the timestamp for the previous transaction and may determine that the timestamps do not exceed an idle duration threshold (which may be configurable). The idle duration is the length of time between the current transaction and the previous transaction. If the idle transaction time does not exceed the idle duration threshold, then it can be assumed that the account balance record is still under saturation.

In step 226, the transaction may update an interim balance record for the account based on the transaction.

In step 228, the transaction processor may receive another new transaction for the account.

In step 230, the transaction processor may determine that there is an active high-volume record lock for the account. For example, the transaction processor may identify an active high-volume record lock in the account record.

In step 232, the transaction processor may determine that the timestamp on previous record exceeds the idle duration threshold.

In step 234, the transaction processor may lock the active account record and may lock an active high-volume record. The account record which has the full balance before entering high volume mode is locked, and the active high-volume record on the lock table is also locked.

In step 236, the transaction processor may update the interim balance record and may initiate an interim merge.

In step 238, the transaction processor may merge all interim balance records for the account with the account record so that the account record reflects all interim transactions.

In step 240, the transaction processor may delete all interim balance records.

In step 242, the transaction processor may release the high-volume lock on the account by deleting the active high-volume record.

In step 244, the transaction processor may publish the confirmed balance for the account record.

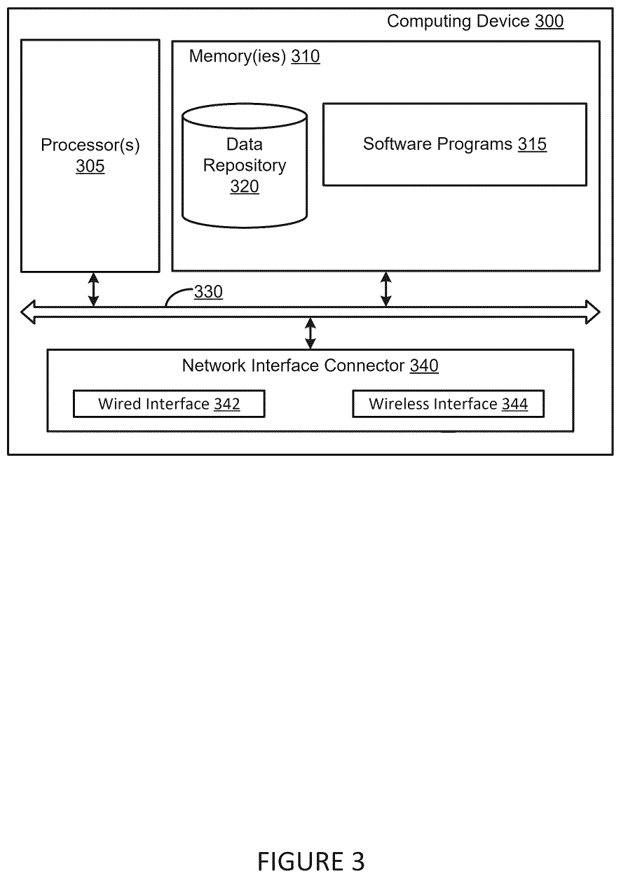

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, at a transaction processor computer program, a first transaction for an account;
determining, by the transaction processor computer program, that there is not an active high-volume record lock on an account record for the account;
acquiring, by the transaction processor computer program, a lock on the account record;
receiving, by the transaction processor computer program, a second transaction for the account;
attempting, by the transaction processor computer program, to acquire a lock on the account record;
determining, by the transaction processor computer program and in response to being unable to acquire a lock on the account record, that a lock acquire duration exceeds a lock acquire duration threshold;
inserting, by the transaction processor computer program, an active high-volume record into a lock table;
creating, by the transaction processor computer program, an interim balance record for the account, wherein the interim balance record aggregates transactions received when the active high-volume record is in the lock table;
receiving, by the transaction processor computer program, a third transaction for the account;
determining, by the transaction processor computer program, that an idle duration between the third transaction and the second transaction does not exceed an idle duration threshold; and
deleting, by the transaction processor computer program, the active high-volume record from the lock table and the interim balance records.

2. The method of claim 1, further comprising:
publishing, by the transaction processor computer program, an account balance event to balance consumers.

3. The method of claim 1, wherein the transaction processor computer program acquires the lock on the account record via a lock manager application programming interface.

4. The method of claim 1, wherein the lock acquire duration indicates whether the account record is being updated by concurrent processes for a period of time.

5. The method of claim 1, further comprising:
merging, by the transaction processor computer program, the interim balance record for the account with the account record.

6. The method of claim 5, further comprising:
deleting, by the transaction processor computer program, the interim balance record after the merging.

7. A system, comprising:
a money movement platform;
a global load balancer in communication with the money movement platform;
a plurality of gateways in communication with the global load balancer;
a transaction processor associated with each of the gateways; and
a data store associated with each transaction processor;
wherein:
the global load balancer is configured to receive a first transaction for an account from the money movement platform;
the global load balancer is configured to route the first transaction to one of the gateways;
the gateway is configured to route the first transaction to its transaction processor;
the transaction processor is configured to determine that there is not an active high-volume record lock on an account record for the account;
the transaction processor is configured to acquire a lock on the account record;
the transaction processor is configured to receive a second transaction for the account;
the transaction processor is configured to attempts to acquire a lock on the account record;
the transaction processor is configured to determine, in response to being unable to acquire a lock on the account record, that a lock acquire duration exceeds a lock acquire duration threshold;
the transaction processor is configured to insert an active high-volume record into a lock table;
the transaction processor is configured to create an interim balance record for the account, wherein the interim balance record aggregates transactions received when the active high-volume record is in the lock table;
the transaction processor is configured to receive a third transaction for the account;
the transaction processor is configured to determine that an idle duration between the third transaction and the second transaction does not exceed an idle duration threshold; and
the transaction processor is configured to delete the active high-volume record from the lock table and the interim balance records.

8. The system of claim 7, wherein the global load balancer is configured to route the first transaction to one of the gateways using an algorithm.

9. The system of claim 7, wherein the transaction processor is configured to publish an account balance event to balance consumers.

10. The system of claim 7, wherein the transaction processor is configured to acquire the lock on the account record via a lock manager application programming interface.

11. The system of claim 7, wherein the lock acquire duration indicates whether the account record is being updated by concurrent processes for a period of time.

12. The system of claim 7, wherein the transaction processor is configured to merge the interim balance record for the account with the account record.

13. The system of claim 12, wherein the transaction processor is configured to delete the interim balance record after the merging.

14. A non-transitory computer readable storage medium, including instructions stored thereon, which when read and executed by one or more computer processors, cause the one or more computer processors to perform steps comprising:
receiving a first transaction for an account;
determining that there is not an active high-volume record lock on an account record for the account;
acquiring a lock on the account record;
receiving a second transaction for the account;
attempting to acquire a lock on the account record;
determining, in response to being unable to acquire a lock on the account record, that a lock acquire duration exceeds a lock acquire duration threshold;
inserting an active high-volume record into a lock table;
creating an interim balance record for the account, wherein the interim balance record aggregates transactions received when the active high-volume record is in the lock table;
receiving a third transaction for the account;
determining that an idle duration between the third transaction and the second transaction does not exceed an idle duration threshold; and
deleting the active high-volume record from the lock table and the interim balance records.

15. The non-transitory computer readable storage medium of claim 14, further including instructions stored thereon, which when read and executed by the one or more computer processors, cause the one or more computer processors to perform steps comprising:
publishing an account balance event to balance consumers.

16. The non-transitory computer readable storage medium of claim 14, wherein the lock on the account record is acquired via a lock manager application programming interface.

17. The non-transitory computer readable storage medium of claim 14, wherein the lock acquire duration indicates whether the account record is being updated by concurrent processes for a period of time.

18. The non-transitory computer readable storage medium of claim 14, further including instructions stored thereon, which when read and executed by the one or more computer processors, cause the one or more computer processors to perform steps comprising:
merging the interim balance record for the account with the account record.

19. The non-transitory computer readable storage medium of claim 18, further comprising:
deleting the interim balance record after the merging.
